(19) United States
(12) Patent Application Publication
(10) Pub. No.: US 2022/0277228 A1
(43) Pub. Date: Sep. 1, 2022

(54) SYSTEMS AND METHODS OF UTILIZING MACHINE LEARNING COMPONENTS ACROSS MULTIPLE PLATFORMS

(71) Applicant: Verint Americas Inc., Alpharetta, GA (US)

(72) Inventors: James Nies, Carmel, IN (US); Matthew Pyke, Morgan Hill, CA (US); Paul Gorman, Renfrewshire (GB); Ash Sood, Renfrewshire (GB); Neil Eades, Renfrewshire (GB); Grant Anderson, Renfrewshire (GB); Alastair Grant, Renfrewshire (GB)

(21) Appl. No.: 17/683,332

(22) Filed: Feb. 28, 2022

Related U.S. Application Data
(60) Provisional application No. 63/154,095, filed on Feb. 26, 2021.

(51) Int. Cl. G06N 20/00

(52) U.S. Cl. CPC G06N 20/00

(57) ABSTRACT

An artificial intelligence (AI) application uses an external machine learning component from a different computing environment to develop context data for use by the AI application. The context data includes raw data outputs from the external machine learning component. An active machine learning component is executed with the context data and provides a suggested next step to a computer to implement as an automated output. A feedback loop adds the suggested next step from the active machine learning component to the context data and forms an augmented data set for providing context to the AI application. A context component selects a rule from a rules engine that corresponds to the augmented data set. The computer implements an automated output according to the rule that was selected.

### CROSS-REFERENCE TO RELATED APPLICATIONS

This application claims priority to and incorporates entirely by reference U.S. Provisional Patent Application Ser. No. 63/154,095, filed on Feb. 26, 2021, and entitled “STRUCTURE FOR MAKING EXTERNAL AI/ML MODELS EFFECTIVE IN ENGAGEMENT MANAGEMENT ENTERPRISES.”

### BACKGROUND

Machine Learning (ML) and Artificial Intelligence (AI) systems are in widespread use in customer service, marketing, and other industries. Machine learning is considered a subset of a more general artificial intelligence operation, and generally, AI endeavors may utilize numerous instances of machine learning to make decisions, predict outputs, and perform human-like intelligent operations. Machine learning protocols typically involve programming a model that instantiates an appropriate algorithm, training the model on a particular data set or domain with known historical results, and using the protocol within an overall design for a specific use case. Machine learning (ML) includes, but is not limited to, a number of models, including neural networks, deep learning algorithms, support vector machines, data clustering, regression models, Monte Carlo simulations, and many more such as Linear regression, Logistic regression, Support vector machine, K-means clustering, Neural network, classification model: binary classifier; multi-class classifier, Clustering model, Anomaly detection, Other Supervised learning model, Other unsupervised learning model, Combination of one or more ML model types. Most of these take vectors of data as inputs.

Some machine learning models are designed for a specific data set or domain and are highly expert at handling the nuances within that narrow domain. For example, a model for recognizing spoken words will be highly tuned to the acoustic and linguistic aspects of speech and conversation. While effective for the intended use case, these systems are difficult to apply a new or different use case. For example, re-using a model designed to provide a score for a credit score would be difficult (requiring involving time, effort, and specialized expertise) to apply to a retention model where the credit score algorithm could be an effective input.

A need exists in the art of machine learning and artificial intelligence for utilizing existing machine learning components that have been programmed and trained for one kind of use in other applications. Artificial intelligence operations in a particular data or calculation context can be enhanced if other machine learning components from other processes can be used to enhance more than one activity.

### BRIEF SUMMARY OF THE DISCLOSURE

According to certain embodiments, a system executes an artificial intelligence (AI) application with a computer having a processor connected to computer memory in data communication with the AI application. An external machine learning component is in data communication with the computer, and the external machine learning component utilizes computer implemented computations to yield raw data outputs that are transmitted to the computer. A context component receives a context data set from the computer, and the context component also receives the raw data outputs from the external machine learning component. An active machine learning component is executed by the computer and is in data communication with the context component, wherein the active machine learning component uses a context data set and the raw data outputs to transmit a suggested next step back to the computer for adding to the context data set and forming an augmented data set. The context component queries a rules database and selects a rule that corresponds to the augmented data set that includes the suggested next step. The computer implements an automated output according to the rule that was selected.

In other embodiments, a computer implemented method includes the steps of querying an external machine learning component with a computer and retrieving raw data outputs from the external machine learning component. The raw data outputs result from computer implemented computations directed to a first business sector. The computer transmits the raw data outputs to a context component stored on the computer and combines the raw data outputs from the external machine learning component with context data gathered by the computer to form combined context data. The method continues with querying an active machine learning component with the combined context data to output a suggested next step to be executed by the computer. The method includes transmitting the suggested next step back to the context component for adding to the combined context data and forming an augmented data set. Querying a rules database selects a rule that corresponds to the augmented data set that includes the suggested next step from the active machine learning component. Using the computer, the method implements an automated output for a different business sector according to the rule that was selected.

In yet another embodiment, an apparatus for executing an active machine learning software component includes a computer having a processor connected to computer memory, the computer executing the active machine learning software component with a computer implemented method. The method includes steps of retrieving raw data outputs from an external machine learning component; transmitting the raw data outputs to a context component in data communication with the machine learning software component; combining the raw data outputs from the external machine learning component with context data gathered by the computer to form an augmented data set for use by the context component; querying the active machine learning component to receive a suggested next step for the computer and transmitting the suggested next step back to the context component for adding to the augmented data set; querying a rules software program to select a rule that corresponds to the augmented data set that includes the suggested next step from the active machine learning component; and using the computer, implementing an automated output corresponding to the rule.

### BRIEF DESCRIPTION OF THE FIGURES

FIG. 1 is a schematic diagram showing an overview environment in which the machine learning components are used in artificial intelligence operations according to certain embodiments.

FIG. 2 is a schematic diagram of a business sector computer building a context data set from local resources and external machine learning components according to certain embodiments.

FIG. 3 is a schematic diagram of an external machine learning component providing raw data outputs for use in context data according to certain embodiments.

FIG. 4 is a schematic diagram of a business sector computer utilizing combined context data in a machine learning environment according to certain embodiments.

FIG. 5 is a schematic diagram showing the process of using a combination of context data to formulate a suggested next step that has been automatically recommended by an active machine learning component according to certain embodiments.

FIG. 6 is a schematic diagram of a business sector computer utilizing combined context data and suggested next steps to form augmented context data for use in a machine learning environment according to certain embodiments.

FIG. 7 is a schematic diagram of an automated rule that may be executed after selection by a business sector computer according to certain embodiments.

FIG. 8 is a schematic diagram of an automated rule that may be executed to generally engage an automated rule selection process upon certain context conditions according to certain embodiments.

FIG. 9 is an example diagram of one kind of external machine learning component that may be used in accordance with certain embodiments.

FIG. 10A is a schematic diagram of computer hardware that may be utilized to implement machine learning algorithms according to this disclosure.

FIG. 10B is a schematic diagram of a general purpose computer that includes processing power and memory hardware to implement functions described in certain embodiments.

### DETAILED DESCRIPTION

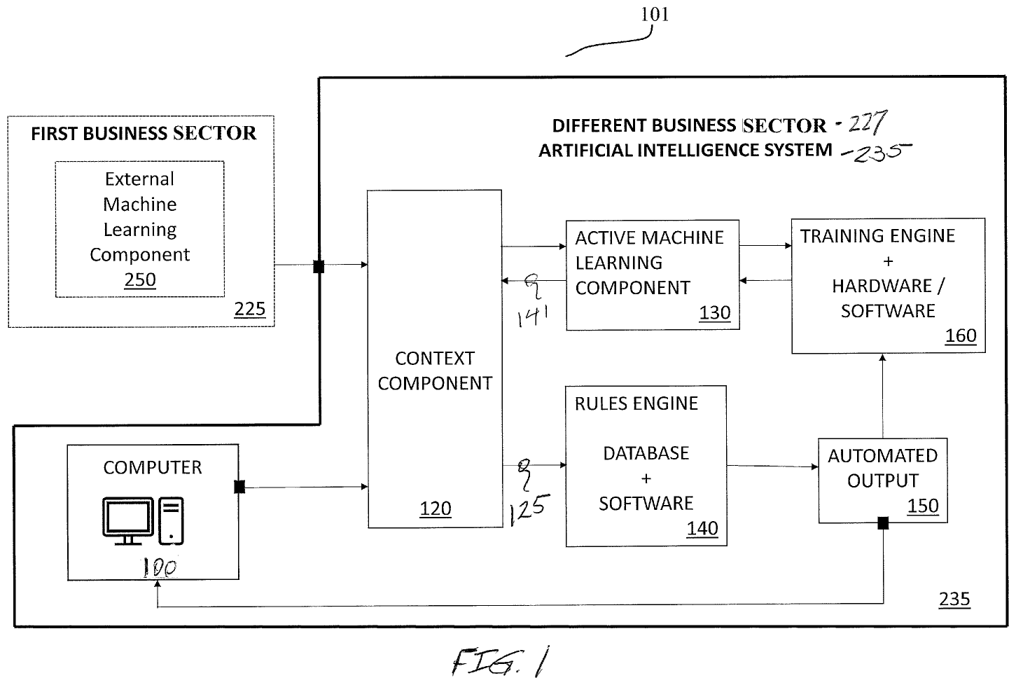

Embodiments of this disclosure are shown in an overview schematic in FIG. 1. Without limiting this disclosure, the example of FIG. 1 shows a first business sector 225 that utilizes an existing instance of machine learning. The first business sector 225 may be any number of operations that utilize machine learning algorithms to systematically and quickly analyze large sets of data to establish patterns, automated rules, electronic responses and the like. In non-limiting embodiments, the first business sector may include multiple operations in a single business or even joint ventures that involve more than one business line. Whatever the business structure, embodiments of this disclosure incorporate at least one external machine learning component 250 that operates in a first business sector 225.

This disclosure is applicable to any number of existing machine learning operations that are available to use across distinct business platforms (i.e., a first business sector 225 and a different business sector 227) so that a multitude of external machine learning components 250 can be available to assist diverse business units, and more particularly, to assist artificial intelligence systems 235 in more than one computing environment. In non-limiting examples of business processes described herein, this disclosure refers to an external machine learning component 250 as an existing software protocol that may have been trained and used in a business sector or computational environment other than the one currently at hand. The business environment at hand, i.e., the different business sector 227 compared to the first business sector 225, is described as utilizing an active machine learning component 130 that is one of several components of an overall artificial intelligence system 235 shown in FIG. 1.

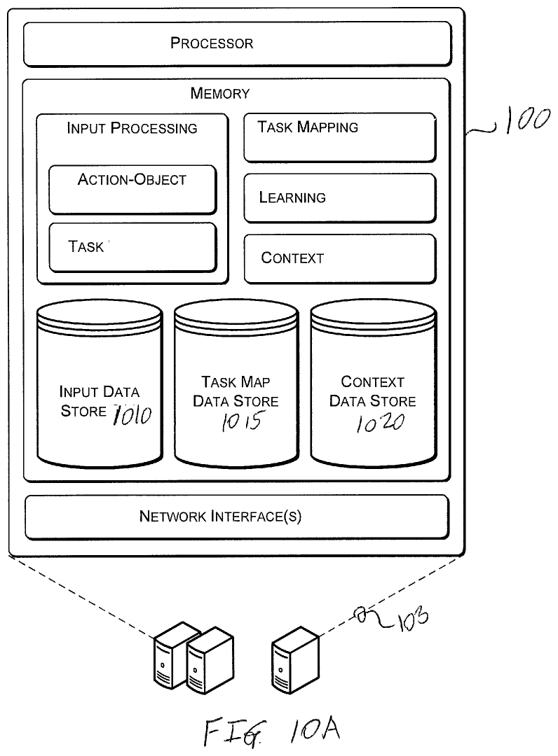

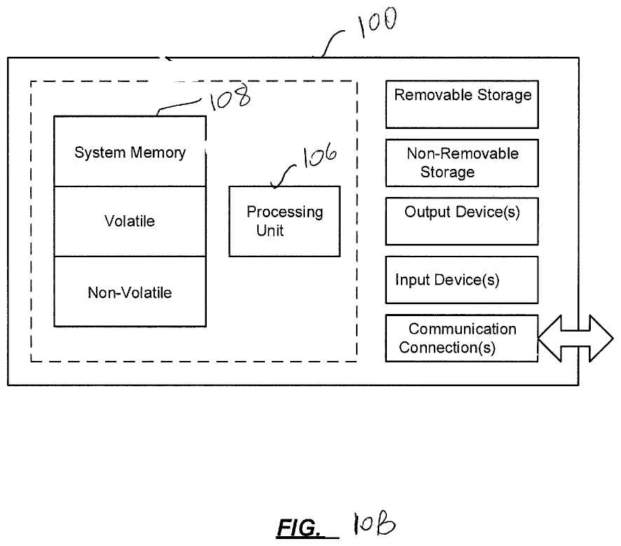

Both the first business sector 225 and the different business sector 227 typically utilize computers and computer-implemented methods to achieve complex data processing results. FIG. 10A illustrates examples of computers 100 that may include the kinds of software programs, data stores, and hardware that can implement machine learning as part of artificial intelligence operations. As shown therein, computers 100 utilized in this disclosure have access to current and historical data inputs in an input data store 1010, mapping operations 1015 for software rule organization, and information regarding a context data store 1020 that machine learning algorithms use to set calculation parameters for a given process. One aspect of this disclosure relates to ensuring that the context data store 1020 used in a machine learning environment has as much relevant information as possible for the machine learning algorithm and the computer 100 to use in automated decision-making. Accordingly, embodiments discussed below are configured to share context data 125 and other common resources between multiple machine learning algorithms executed on various computers 100. As shown in FIG. 10A, the shared data is typically transmitted over a network 103. FIG. 10B shows more generalized components of computers 100 that are often used to implement the complex operations of machine learning and artificial intelligence.

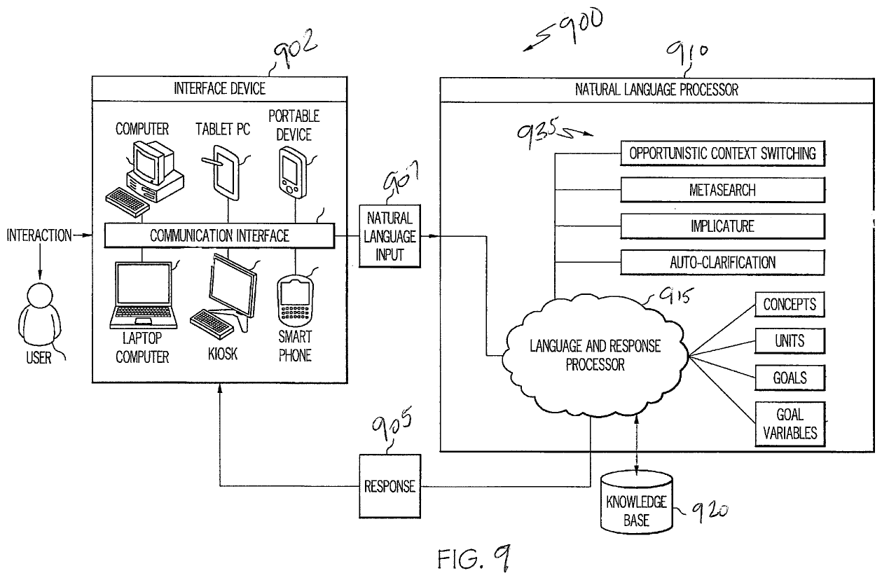

The external machine learning component 250 can be any combination of hardware and software that implements various kinds of machine learning algorithms as part of a first business sector 225. FIG. 9 is one non-limiting example of an existing external machine learning component 250 in the form of an artificial intelligence system 900 that assists in providing suggested responses 905 when a user device 902 has provided a natural language input 907 to a natural language processor 910. In this example, the external machine learning component 250 would include a language and response processor 915 having separate software modules to identify characteristics of the natural language input 907, such as units of language used in the natural language input 907, the concepts embodied in the natural language input, and the goal of the user in providing the communication in the first place. In many machine learning environments, these kinds of decisions made about an input can be used to formulate a suggested response 905. The response is then communicated back to the appropriate communications network and user device 902. As shown in FIG. 9, this example of an external machine learning component 250 utilizes many different kinds of iterative decision-making algorithms that have been trained with historical data and known outcomes to assess a current natural language input 907 and provide the most likely candidate as an appropriate response 905 back to the user device 902. The algorithms used in this illustration of FIG. 9 may include software implementing computerized methods to analyze core aspects 935 of the current input data, e.g., the context, the metadata, known implications in certain words, and clarifying procedures to double-check certain results. One thing to consider in this kind of example of existing machine learning components 250 is how much data processing, electronic know-how, and records of results are available in this one artificial intelligence system 900. Such a data-rich resource for interpreting natural language inputs is useful in many environments other than the single business sector in which it originally operates.

Using machine learning operations directed to natural language processing and automated response, as shown in FIG. 9, is just one non-limiting example of an external machine learning component 250 that can be useful across more than one computing platform. Other external machine learning components 250 may include computerized systems that result in virtual assistant training, automated call center operations, real-time chatbots, customer recommendation engines, customer agent training, and the like. All of these kinds of AI applications learn decision-making routines and have caches of data that could assist additional kinds of computations in different business processes 227. For that reason, embodiments of this disclosure take advantage of cross-training and dual-use of existing machine learning applications that are available to share their electronic know-how and decision-making processes.

One particular data sharing opportunity between an external machine learning component 250 in a first business sector 225 and an active machine learning component 130 is a different business sector 227 lies in context data 125 that is instrumental in an artificial intelligence system because the system uses context data 125 to set parameters for complex calculations and to ensure that the appropriate variables are used in iterative adjustments and error calculations. As shown in the overview FIG. 1, the context data 125, if sufficiently complete as discussed herein, is one basis by which an artificial intelligence system 235 selects a rule from a rules engine 140 that determines an automated output 150. That automated output 150 and its success or failure relative to a particular goal can then be used to track historical results and used in a training engine 160 that most machine learning algorithms depend upon for accurate decision making.

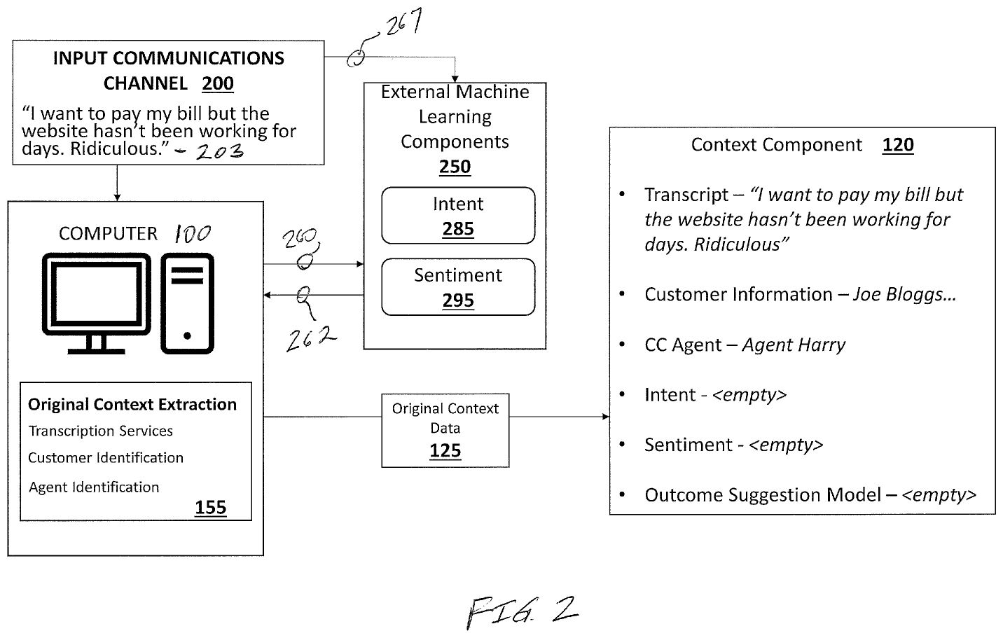

FIGS. 2-8 illustrate how context data 125 can be instrumental in achieving efficient and accurate machine learning techniques but also can be updated through real-time data storage from more than one source. The implementations of FIGS. 2-8 refer back to the above noted natural language input processor 900 of FIG. 9 as one non-limiting example of an external machine learning component 250. As shown in FIG. 2, a computer 100 is utilized in an operation that receives input communications from numerous communications channels. The communications channels can be any kind of data input, including voice, text, chats, image gathering, and the like. In the example of FIG. 2, an input communications channel 200 receives a first communication 203 from a customer regarding bill payment, and the first communication 203 includes words that express unhappiness or dissatisfaction.

In one embodiment, FIG. 2 shows initiation of an artificial intelligence (AI) system 235 that is intended to provide a user or another computer a suggested automated output 150 to respond to the first communication 203 using a computer 100 having a processor 106 connected to computer memory 108 in data communication with the AI system 235. An external machine learning component 250, such as but not limited to the natural language processing system 900 of FIG. 9, is in data communication with the computer 100. As discussed above, the external machine learning component 250 utilizes computer-implemented computations to yield raw data outputs 262 that are transmitted to the computer 100 after the computer submits a query 260 to the external machine learning component 250. Raw data outputs may be in the format in which the external machine language component provides its suggested analysis, such as but not limited to vectors of IVA data, time series data, encrypted data, and the like. Optionally, the computer 100 and the external machine learning component 250 communicate over a network. The computer 100 saves the raw data outputs in memory 108 for use with the AI system 235. In other embodiments, the input communications channel 200 may be configured to simultaneously communicate with both the computer 100 and the external machine learning components 250 via a data link 267 so that both computing devices 100 and 250 can perform their respective tasks at the same time. In the example of FIG. 2, the external machine learning component 250 includes machine learning algorithms configured to receive the first communication 203 and use the natural language processing system 900 to decide at least the user's intent with an intent engine 285 and a user's sentiment with a sentiment calculation engine 295 implemented on an external computer, optionally within the first business sector of FIG. 1. The intent data and sentiment data are provided to the computer 100 operating in the different business sector 227 that is depicted, for example, purposes as being separate and distinct from the first business sector of FIG. 1 that originally used the external machine learning component 250. In other words, the external machine learning component 250 may have been trained with original external data, specific parameters, and unique variables that are distinct from the different business sector 227 at hand in the example of FIG. 2.

The computer 100 not only receives the raw data outputs 262 from the external machine learning component 250, but the computer 100 is further programmed to engage in original content extraction 155 and parse the first communication 203 from the input communications channel 200. Accordingly, computer 100 is depicted as being configured to transcribe the first communication 203 from any available incoming channel of communication and extract certain original context data from that first communication 203. The channels of communication are not limited but can include numerous kinds of text, voice, image data, and the like. For example, and without limitation, the computer 100 can extract objective information from an input data set such as a customer name, customer account number, customer payment history, and/or any agent assigned to the customer from a transcribed version of the first communication 203. These are just useful examples from one kind of commercial enterprise dealing with customers and utilizing the example embodiments of this disclosure.

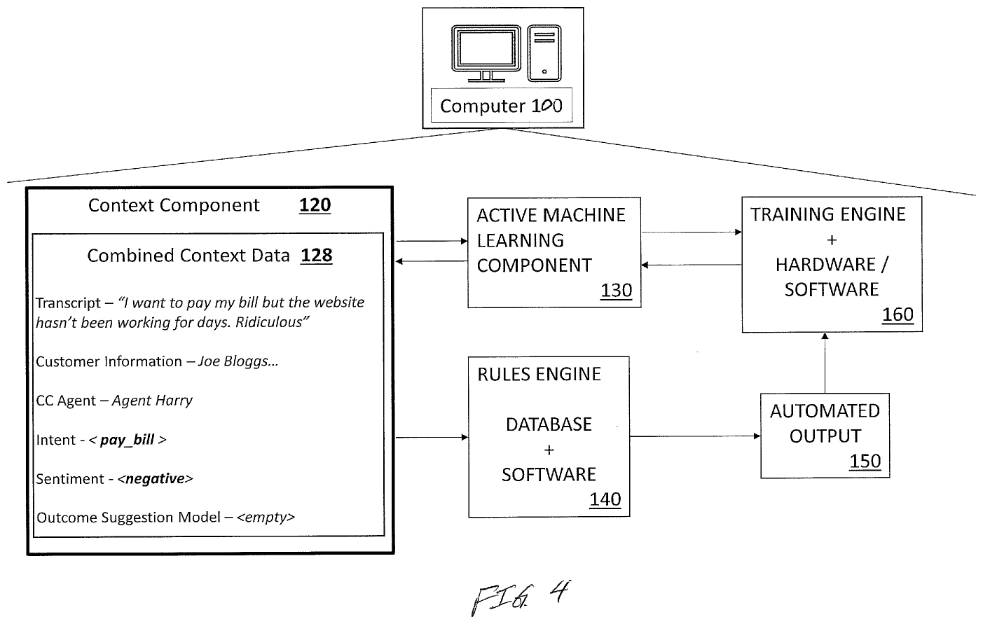

The AI system 235 of one implementation of this disclosure includes a context component 120 that can receive and store a context data set 125 from the computer 100. The context component 120 may be any kind of data storage device, file, database, table, or the like, without limitation, and can be part of the computer 100 or stored separately, such as on a network server, so long as the computers of this disclosure have access to the context data set 125 and/or supplemented versions thereof for use in machine learning. The context component 120 also receives the raw data outputs 262 stored on the computer 100 from the external machine learning component 250. In this sense, the context component 120 receives combined context data 128 that includes the context data set 125 extracted by the computer 100 along with the raw data outputs 262 from the external machine learning component 250. This is shown in more detail in FIG. 4.

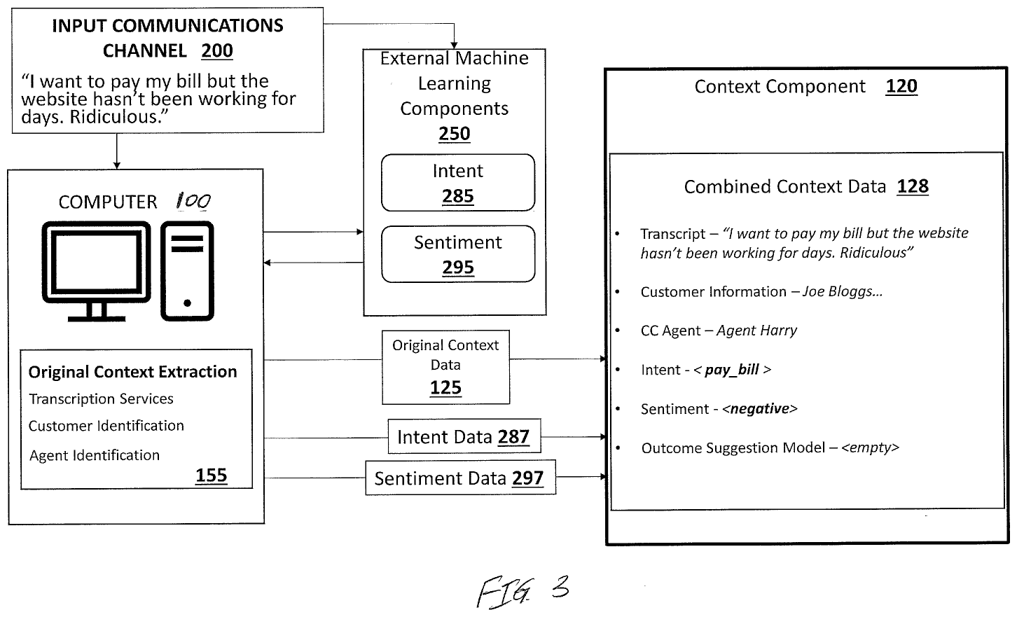

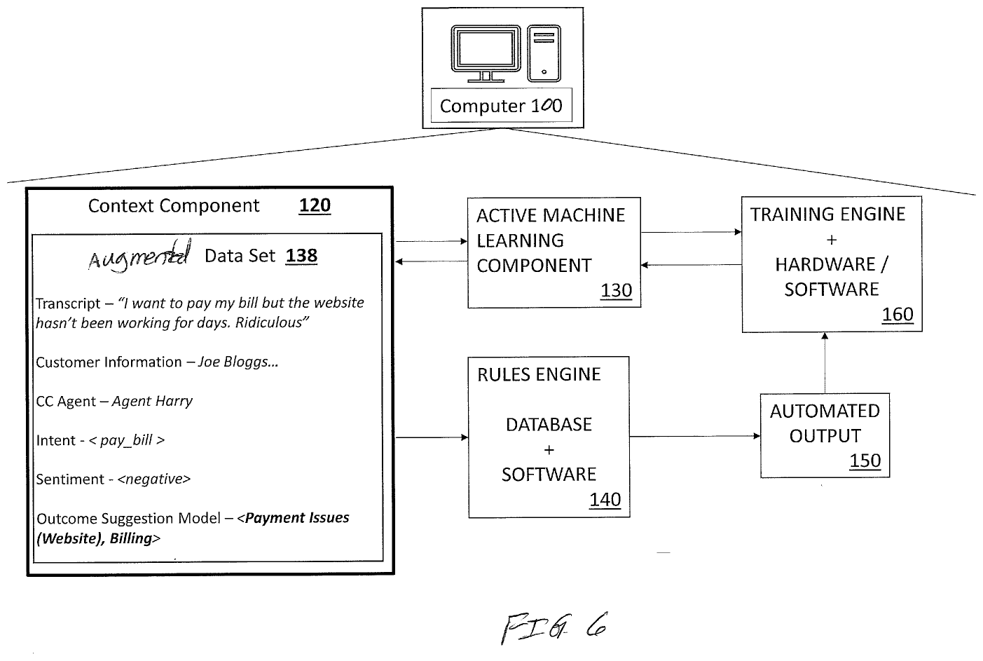

The artificial intelligence system 235 within a business sector at hand (i.e., the different business sector 227) also has its own internal machine learning component, referred to for clarity purposes only as the active machine learning component 130. The active machine learning component 130 may be executed by the computer 100 (or another connected computer) and is in data communication with the context component 120. The active machine learning component 130 uses at least the context data set 125, and the raw data outputs 262 to transmit a suggested next step 141 back to the computer 100. The computer 100 not only stores this suggested next step for additional data processing, but in some embodiments, computer 100 adds the suggested next step to the context data set 125 (or the combined context data 127 of FIG. 3 and FIG. 4) and forms an augmented data set 138 shown for example in FIG. 6. This augmented data set is particularly useful in that it incorporates work divided among the computer 100, the external machine learning component 250, and the active machine learning component 130 that is internal to the AI system 235 currently used to handle the first communication 203 from a customer.

With the augmented context data set 138 complete, the context component 120 has sufficient information to use the computer 100 and query a rules database 140 to select a rule that corresponds to the augmented data set 138. In this non-limiting example, the suggested next step 141 produced by the active machine learning component 130 becomes part of the information stored in the context component 120 and is a defined variable for at least one rule selected to respond to the first communication 203 from the customer. Accordingly, computer 100 implements an automated output 150 according to the rule that was selected.

Machine learning components of this disclosure may utilize any algorithm by which a computer analyzes historical data, historical suggestions, and results of those previous attempts. The exact algorithm may be chosen and customized according to numerous factors dictated by the intended use. In the examples of FIGS. 2-8, the active machine learning component 130 includes computer programming and appropriate hardware that implement a training engine 160 that iteratively learns a series of historical results that have previously resulted from combinations of historical context data and historical selections of rules. The active machine learning component uses this training from the training engine 160 to predict outcomes for the AI system 235 by iteratively evaluating the augmented data set 138, the suggested next step 141, and the automated output 150 for a plurality of combinations of context data 125 from the computer 100, raw data outputs 262 from the external machine learning component 250, and even suggested responses 141 that have become part of the augmented context data 138. It is significant that the external machine learning component 250 can provide machine learning services and data processing for a particular kind of data in its home domain (i.e., its original domain of variables) and assist the active machine learning component 250 in calculating solutions for an independent and possibly unrelated process.

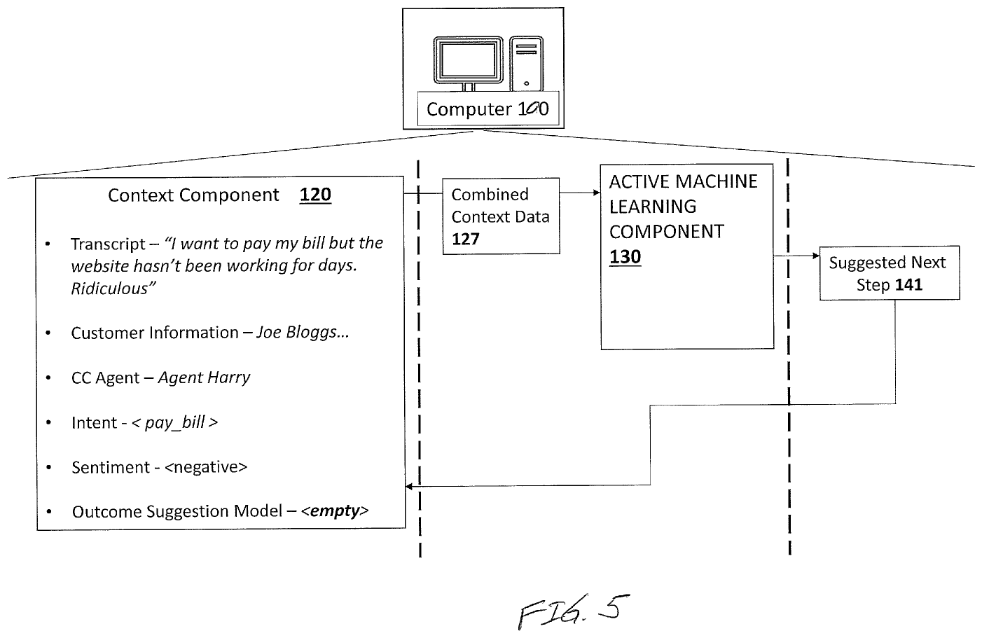

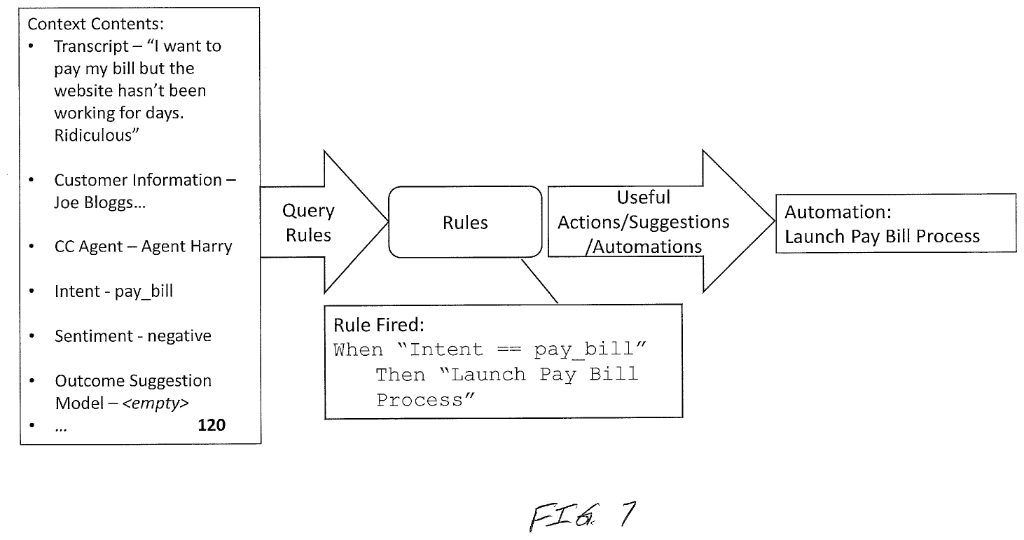

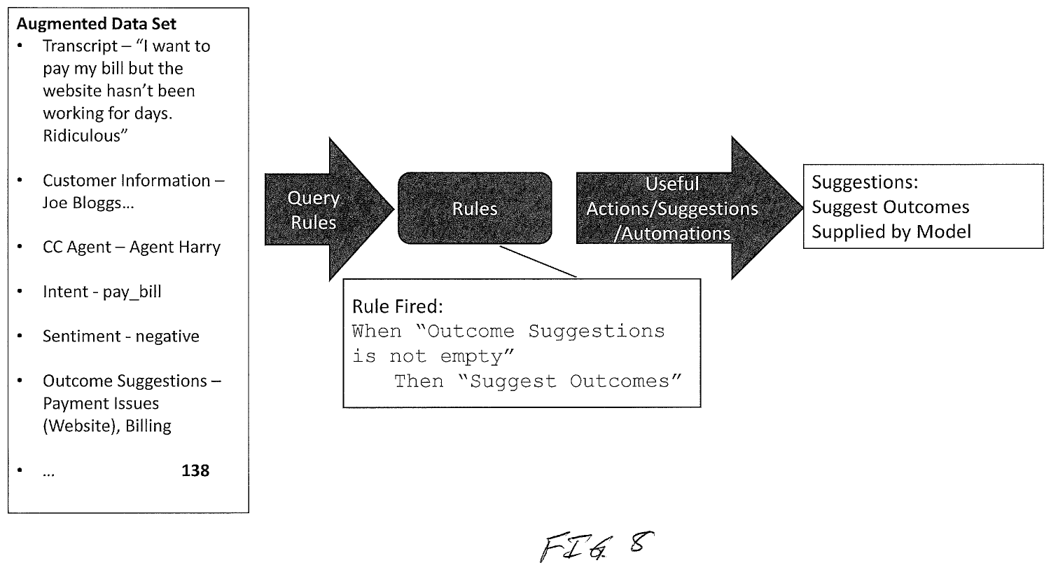

The computer 100 can be configured, therefore, to execute a computer-implemented method in accordance with the system described above by querying an external machine learning component 250 and retrieving the raw data outputs 262 from the external machine learning component 250, even when the raw data outputs result from computer-implemented computations directed to a first business sector 225 and the computer is actually operating directly within a different business sector 227 as illustrated by the example of FIG. 1. The query 260 results in the external machine learning component 250 transmitting the raw data outputs 262 to a context component 120 stored on the computer 100. The computer then combines the raw data outputs from the external machine learning component with context data 125 gathered by the computer to form combined context data 128. In the example of FIG. 2, the original context component 120 had certain blank fields for the variables of “intent,” “sentiment,” and “outcome suggestion model.” By querying the external machine learning component 250 and providing it with the first communication 203 received at the computer (either simultaneously or by separate transmission), computer 100 is able to fill in the intent data 287 and the sentiment data 297 as shown in FIG. 3. This results in the combined context data 128, as shown. FIG. 4 and FIG. 5 show the next step of the method—querying the active machine learning component 130 with the combined context data 128 to output a suggested next step 141 to be executed by the computer 100. Though not perfect, the combined context data 128 is a much more complete data set than that which would be available only from the computer 100 and its original context extraction 155 capabilities of FIG. 2. Accordingly, the active machine learning component 130 would have sufficient information to provide a reliable suggested next step 141. In order to make future next steps even more reliable, however, the computer-implemented method includes transmitting the suggested next step 141 back to the context component 120 for adding to the combined context data 128 and completing an empty field entitled “outcome suggestion model” as set forth in FIG. 5. Once that field has been completed in the non-limiting example of this disclosure, the computer has formed and stored an augmented data set 138 shown in FIG. 6. The method, therefore, continues by querying a rules database 140 to select a rule that corresponds to the augmented data set 138 that includes the suggested next step 141 from the active machine learning component 130. With the best rule chosen, the computer is configured to implement an automated output 150 for the business sector according to the rule that was selected. FIG. 7 illustrates a selected rule being utilized by the computer 100. One non-limiting way to describe the iterations of FIGS. 2-6 is that the artificial intelligence system 235, outlined within the business sector 227 of FIG. 1, can become a feedback loop in which the active machine learning component 130 iteratively calculates suggested next steps 141 and sequentially transmits the suggested next steps 141 to the context component 120 for combining with the augmented data set 138. In one sense, the previously suggested next step becomes a part of the context data for the next iteration of selecting a rule and the next suggested next step. In this way, the rules engine can also be updated according to the successes and failures of the suggested next steps. Some applications may choose to map preferred rules to certain corresponding items in the context component for fast retrieval of a suggested next step. For example, in FIG. 8, a mapping may initiate a certain rule procedure when the context data includes certain expected items therein.

The computer 100 may be configured as a stand-alone apparatus that incorporates sufficient hardware and software to execute the above-noted method.

The present disclosure has been described with reference to example embodiments, however, persons skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability.

Accordingly, all such modifications are intended to be included within the scope of the present disclosure. Other substitutions, modifications, changes, and omissions may be made in the design, operating conditions, and arrangement of the preferred and other exemplary embodiments without departing from the spirit of the present subject matter.

In example implementations, at least some portions of the activities may be implemented in software provisioned on a networking device. In some embodiments, one or more of these features may be implemented in computer hardware, provided external to these elements, or consolidated in any appropriate manner to achieve the intended functionality. The various network elements may include software (or reciprocating software) that can coordinate image development across domains such as time, amplitude, depths, and various classification measures that detect movement across frames of image data and further detect particular objects in the field of view in order to achieve the operations as outlined herein. In still other embodiments, these elements may include any suitable algorithms, hardware, software, components, modules, interfaces, or objects that facilitate the operations thereof.

Furthermore, computer systems described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that single processor and a single memory element are responsible for certain activities. In a general sense, the arrangements depicted in the Figures may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some example embodiments, one or more memory elements (e.g., memory can store data used for the operations described herein. This includes the memory being able to store instructions (e.g., software, logic, code, etc.) in non-transitory media, such that the instructions are executed to carry out the activities described in this Specification. A processor can execute any type of computer-readable instructions associated with the data to achieve the operations detailed herein in this Specification. In one example, processors (e.g., processor) could transform an element or an article (e.g., data) from one state or thing to another state or thing. In another example, the activities outlined herein may be implemented with fixed logic or programmable logic (e.g., software/computer instructions executed by a processor), and the elements identified herein could be some type of a programmable processor, programmable digital logic (e.g., a field-programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory storage medium (e.g., random access memory (RAM), read-only memory (ROM), field-programmable gate array (FPGA), erasable programmable read-only memory (EPROM), electrically erasable programmable ROM (EEPROM), etc.), software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system that executes an artificial intelligence (AI) application, comprising:
a computer comprising a processor connected to computer memory in data communication with the AI application;
an external machine learning component in data communication with the computer, wherein the external machine learning component utilizes computer implemented computations to generate raw data outputs that are transmitted to the computer;
a context component receiving a context data set from the computer, wherein the context component also receives the raw data outputs from the external machine learning component;
an active machine learning component executed by the computer and in data communication with the context component, wherein the active machine learning component uses the context data set and the raw data outputs to transmit a suggested next step back to the computer for adding to the context data set and forming an augmented data set;
wherein the context component queries a rules database and selects a rule that corresponds to the augmented data set that includes the suggested next step; and
wherein the computer implements an automated output according to the rule that was selected.

2. The system of claim 1, wherein the active machine learning component comprises a machine learning computer program that has been trained by iteratively learning a series of historical results that have previously resulted from combinations of historical context data and historical selections of rules.

3. The system of claim 2, wherein the active machine learning component predicts outcomes for the AI application by iteratively evaluating the augmented data set, the suggested next step, and the automated output for a plurality of combinations of context data from the computer and raw data outputs from the external machine learning component.

4. The system of claim 1, wherein the computer implemented computations of the external machine learning component are independent of the active machine learning component.

5. The system of claim 4, wherein the computer implemented computations of the external machine learning component are directed to a domain of computation variables that is distinct from the AI application.

6. The system of claim 5, wherein the domain of variables applicable to the external machine learning component correspond to a first business process and the automated output from the AI application corresponds to a different business process.

7. The system of claim 1, wherein the context data set and the augmented data set comprise data from a plurality of communication channels.

8. The system of claim 1, wherein the automated output and a corresponding system result is stored in a database of historical results for use in training the active machine learning component.

9. The system of claim 1, wherein the external machine learning component is an intent classifier comprising at least one conversation input.

10. The system of claim 1, wherein the external machine learning component is a sentiment classifier comprising at least one conversation input.

11. The system of claim 1, wherein the context data received from the computer comprises at least one of a transcript of a communication, customer information, customer service agent data, or customer service agent action data.

12. A computer implemented method comprising:
querying an external machine learning component;
receiving raw data outputs from the external machine learning component, the raw data outputs resulting from computer implemented computations directed to a first business process;
transmitting the raw data outputs to a context component stored on the computer;
combining the raw data outputs from the external machine learning component with context data gathered by the computer to form combined context data;
querying an active machine learning component with the combined context data to output a suggested next step to be executed by the computer;
transmitting the suggested next step back to the context component for adding to the combined context data and forming an augmented data set;
querying a rules database to select a rule that corresponds to the augmented data set that includes the suggested next step from the active machine learning component;
using the computer, implementing an automated output for a different business process according to the rule that was selected.

13. The computer implemented method of claim 12, further comprising a feedback loop in which the active machine learning component iteratively calculates suggested next steps and sequentially transmits the suggested next steps to the context component for combining with the augmented data set.

14. The computer implemented method of claim 12, further comprising mapping selected rules to items in the augmented data set.

15. The computer implemented method of claim 12, further comprising receiving raw data outputs from the external machine learning component that have been calculated from a domain of variables that are distinct from the different business process utilizing the active machine learning algorithm.

16. The computer implemented method of claim 12, further comprising training the active machine learning component to iteratively learn a series of historical results that have previously resulted from combinations of historical context data.

17. The computer implemented method of claim 12, further comprising retrieving context data directly from a business transaction completed at least in part by the computer and storing the context data in the context component.

18. The computer implemented method of claim 17, wherein the context data comprises data inputs from multiple communications channels.

19. The computer implemented method of claim 12, further comprising initiating the different business process simultaneously with the first business process providing raw data outputs.

20. The computer implemented method of claim 12, further comprising updating the rule after evaluating the automated output and a corresponding system result.

21. An apparatus for executing an active machine learning software component, the apparatus comprising:
a processor coupled to a computer memory having computer-readable instructions that, when executed by the processor, cause the apparatus to perform a method for executing the active machine learning software component with a computer implemented method comprising:
retrieve raw data outputs from an external machine learning component;
transmit the raw data outputs to a context component in data communication with the machine learning software component;
combing the raw data outputs from the external machine learning component with context data gathered by the computer to form an augmented data set for use by the context component;
query the active machine learning component to receive a suggested next step for the computer and transmitting the suggested next step back to the context component for adding to the augmented data set,
query a rules software program to select a rule that corresponds to the augmented data set that includes the suggested next step from the active machine learning component;
implement an automated output corresponding to the rule.

22. The apparatus of claim 21, wherein the computer further implements a feedback loop comprising:
receive updated raw data outputs from the external machine learning component at the context component;
form a respectively augmented data set with the updated raw data outputs;
sequentially query the active machine learning component with the respectively augmented data set; and
continuously update the context component with respectively suggested next steps from the active machine learning component.

23. The apparatus of claim 22, wherein the computer uses the respectively suggested next steps to edit the rules software program.
